(19) United States
(12) Patent Application Publication
(10) Pub. No.: US 2006/0111799 A1
(43) Pub. Date: May 25, 2006

(54) Fire risk assessment system

(76) Inventors: Tom Eggenberger, Woodbury, MN (US); Delbert Cox, Marshall, MN (US); Michele Cook, Farmington, MN (US); Seth Edmund Ostrander IV, Marshall, MN (US); Richard M. Sharp, Lynd, MN (US); Carlos Hazim, Marshall, MN (US); Jeffrey Pieschke, Marshall, MN (US)

Correspondence Address: Erik G. Swenson;Merchant & Gould P.C., P.O. Box 2903, Minneapolis, MN, 55402-0903, US

(21) Appl. No.: 10/966,157

(22) Filed: Oct. 15, 2004

(51) Int. Cl. G06F 17/00; G06F 19/00

(52) U.S. Cl. 700/91; 700/90

(57) ABSTRACT

In one aspect of the present invention, a fire risk assessment system comprises a data storage unit, a customer interface, a location unit, and a protection status unit. The data storage contains fire station information. The customer interface accepts address data and outputs fire station, address and protection status information. The location unit calculates locations of addresses, calculates driving distances from fire stations and determines whether that location is within a municipality. A protection status unit assigns a protection status to the address based on fire station distance and municipality status information.

### TECHNICAL FIELD

The present invention is generally related to fire risk determinations; more specifically the invention relates to fire risk assessment of properties based on distance from fire stations and other factors.

### BACKGROUND

Home owners insurance premiums are significantly affected by a property's relative risk of fire damage. In turn, fire damage risk is affected by both the availability of a water supply and the distance for the insured property to the nearest fire station(s). These factors directly affect the risk exposure of the property.

The verification of protection status of a homeowner's property is a time-consuming, manual process. Proof of fire protection for insurance coverage is well established as a valuable risk assessment tool.

Fire damage risk may be determined electronically by referencing a property address to a municipality map and to a database containing locations of fire stations. The municipality map determines whether the insured property is within a municipality and therefore assumed to have water access.

Such fire risk determinations are difficult when input address information is incomplete or ambiguous. In these cases, systems may either return an error or incorrectly estimate which address is desired. Typically, existing systems also apply a radial distance estimation technique. This distance determination may calculate inaccurate results.

Therefore, improvements are desirable.

### SUMMARY

In accordance with the present invention, the above and other problems are solved by the following:

In one aspect of the present invention, a fire risk assessment system comprises a data storage unit, a location unit, a customer interface, and a protection status unit. The data storage unit contains geographic locations of one or more fire stations. The location unit is connected to the data storage unit and the customer interface. The location unit accepts a customer-entered address from the customer interface. The location unit then spatially plots, standardizes and geocodes the address, locates the nearest fire station(s), and calculates a driving, Manhattan and straight line distance from one or more nearest fire stations to the address. The system assigns a municipality status to the address that is determined by whether the property at that address resides within a municipality. The customer interface is associated with the location unit, and is capable of accepting the customer-entered address and outputting distance and protection status data. The protection status unit is connected to the location unit and the customer interface, and is capable of calculating a fire protection status, which corresponds to the customer-entered address and it's nearest fire station(s).

In another aspect of the present invention, a method of assessing fire risk is disclosed. The method comprises accepting one or more entries containing preformatted address data. The method further comprises geocoding the preformatted address data. The method also comprises determining whether the address data corresponds to a recognized location within a municipality. The method also comprises calculating a driving distance from the recognized location to one or more closest fire stations. A protection status is derived, corresponding to the recognized location. The driving distance and protection status are output in a standard format.

In another aspect of the present invention, a graphical user interface for a fire risk assessment system is disclosed. A first viewing area displays an address input form, wherein the firm comprises one or more input fields that accept address data. A second viewing area displays a single address match candidate or list of possible address candidates and corresponding United States Postal match quality description. A third viewing area displays a fire risk report, wherein the fire risk report contains text fields comprising address information, geo-code information, locations proximity to municipal boundary, fire protection status information, and distance information. A fourth viewing area displays a spatial map detailing the address input location and the fire stations identified on the fire risk report.

In another aspect of the present invention, a computer-readable medium encoding computer executable instructions for executing on a computer a process for assessing fire risk is disclosed. The process involves geocoding address data, and determining whether the address data corresponds to a location within a municipality. The process involves calculating driving distance from this location to one or more nearby fire stations. The process further involves outputting the driving, Manhattan, and straight line distance and protection status for all stations returned.

In another aspect of the present invention, a computer-readable medium storing a data structure that identifies fire station locations is disclosed. The data structure contains an identifier field containing name data of one or more fire stations. The data structure contains one or more fire station location fields containing location data corresponding to the physical location of each fire station represented by an identifier field entry. This location field is usable to calculate a driving distance to a reference location. The data structure also contains a type field containing fire station type data corresponding to each fire station represented by an identifier field entry.

### BRIEF DESCRIPTION OF THE DRAWINGS

FIG. 1 is a block diagram of a fire risk assessment system;

FIG. 2 is a schematic representation of a computing system that may be used to implement aspects of the present invention;

FIG. 3 is a diagram of a fire risk assessment system according to one possible embodiment of the present invention;

FIG. 4 is a flowchart of a process in a risk assessment system;

FIG. 5 is a diagram displaying a method to determine the municipality status of a low quality address match according to one possible embodiment of the present invention;

FIG. 6 is a block diagram of a method of assessing fire risk;

FIG. 7 is a detailed flowchart of a method and system of assessing fire risk according to an example embodiment of the present invention;

FIG. 8 is a graphical user interface screen illustrating an address input form displayed on a popular Web browser, according to one possible embodiment of the present invention;

FIG. 9 is a graphical user interface screen illustrating a candidate list for the input address in standardized form with its corresponding match location quality displayed on a popular Web browser, according to one possible embodiment of the present invention;

FIG. 10 is a graphical user interface screen illustrating a fire risk report displayed on a popular Web browser, according to one possible embodiment of the present invention; and

FIG. 11 is a graphical user interface screen illustrating a customer entered address and nearest fire stations on a street map displayed on a popular Web browser, according to one possible embodiment of the present invention.

### DETAILED DESCRIPTION

In general terms the present disclosure relates to a fire risk assessment system capable of locating the closest fire stations to a customer-entered address. The fire risk system accepts the address through an interface and then standardizes and geocodes the address. The fire risk assessment system determines the Manhattan, straight line and driving distance from those fire stations near to the address, and determines whether the address is located within a municipality. Based on these determinations, the system assigns a protection status to the address. The distance and protection status are output through the interface.

The present disclosure utilizes mapping and location algorithms known as geospatial technology. Geospatial technology allows for automating the computation of property locations for input into a risk algorithm. Combining data from various sources with geospatial data technology and a database of fire station information provides insurance companies with timely, accurate data regarding the risk of fire. Straight line, Manhattan (right angle) and Drive distances are automatically calculated using longitude and latitude data and routing technology.

A system according to the present disclosure determines the distance between the customer-entered address and the nearest fire stations through the use of a routing technology. This method of determining distance provides more accurate distance information to the consumer because it accounts for unexpected barriers to travel such as mountains, waterways, or bridges.

The present disclosure improves risk assessment by increasing accuracy. This is accomplished in part by emphasizing human factors in the risk assessment. Users may customize certain aspects of the risk assessment determination and are prompted for information when user-entered address data corresponds to potential multiple locations.

An example of this may be when a customer fails to enter a directional modifier to a street address. An entry of “100 Main St.” may be intended to be 100 South Main St. or 100 North Main St. The present disclosure anticipates these ambiguities and discloses a system that prompts customers for clarification when needed.

This disclosure also involves a method of assessing fire risk. The method involves accepting address data, geocoding the address, determining whether the address is in a municipality, calculating a driving distance to the address from the closest few fire stations, deriving a protection status, and outputting the driving straight line, and Manhattan distance and protection status. This method is advantageous for fire risk assessments, but may also be utilized in other location-based systems.

This disclosure also involves a graphical user interface connected to a fire risk assessment system. The graphical user interface includes an address input form, an address selection form, a fire risk report, and a corresponding map display.

This disclosure also involves a computer-readable medium encoding computer executable instructions for executing a process for assessing fire risk. The process involves geocoding address data, and determining whether the address data corresponds to a location within a municipality. The process involves calculating driving, straight line and Manhattan distances from this location to one or more nearby fire stations. The process further involves outputting the driving distance and protection status.

This disclosure also incorporates a data structure that identifies fire station locations. The data structure contains an identifier field containing name data of one or more fire stations. It also contains one or more fire station location fields containing location data corresponding to the physical location of each fire station represented by an identifier field entry. This location field is usable to calculate driving, straight line and Manhattan distances to a reference location. The data structure further contains a type field containing fire station type data corresponding to each fire station represented by an identifier field entry.

The logical operations of the various embodiments of the present disclosure can be implemented as a sequence of computer implemented steps running on a computing system. The implementation is a matter of choice dependent on the performance requirements of the computing system implementing the disclosure. The invention may be implemented as a computer process, a computing system, or as an article of manufacture such as a computer program or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

The following is a representative example of a fire risk assessment system and accompanying method of assessing fire risk: A customer has a preexisting account allowing the customer to access a customer interface. The customer interface may be either a graphical user interface operated as a web application, or a customer-developed proprietary solution. A standard communication format, such as XML or a similar programming language may be used to communicate with the customer interface. The customer is able to enter the address of one or more locations into the customer interface.

The customer interface may be implemented to include an application to application communication standard. This application to application system can use the standard communication format, such as XML, to allow a customer to develop proprietary solutions. In this embodiment, it is possible for a customer to send information, for example in an electronic file, including multiple addresses. The fire risk assessment system will then return multiple fire protection statuses in a similar format.

The customer interface may alternately be implemented to include a web application. This web application may be a graphical user interface that communicates with the rest of the risk assessment system and allows customer entry of individual addresses and selective ordering of risk reports by the customer.

Regardless of whether the customer interface is implemented by using a web application or a customer-oriented proprietary solution, the fire risk assessment system input elements. These elements are provided to the fire risk assessment system in a standard format. In an example embodiment of the present disclosure, input file elements include those described in Table 1, which may be implemented in an XML-type input or output file:

TABLE 1

| Data Element | Requirements |
|---|---|
| Account Number | Required |
| Data Type | Required |
| Explore Account Number | Required |
| Policy Number | Required |
| Agency Number | Required |
| Quote Back | Customer Use |
| Renewal Date | Customer Use |
| Last Name | Required |
| Address Line | Required |
| City | Required |
| State | Required |
| Zip Code | Required |
| Record ID | Required |
| Customer Company ID | Optional |

Table 2 provides a description of the uses of these fields:

TABLE 2

| Field Name | Type | Length | Description |
|---|---|---|---|
| FireSafeRequest | | | |
| Customer | N | 9 | Customer Account Number |
| ReportingAccount | N | 9 | Customer Account Number |
| DataType | C | 1 | Represents type of data that is sent. |
| | | | P = Production, T = Test |
| Config | | | |
| PolygonDistance | N | 2.2 | Future use |
| Product | | | Future use |
| Policy | | | |
| Number | C | 32 | Insurance Policy Identifier |
| | | | (Returned in output without |
| | | | modification) |
| Agency | C | 32 | Insurance Agency Identifier |
| | | | (Returned in output without |
| | | | modification) |
| QuoteBack | C | 60 | For customer use only (Returned |
| | | | in output without modification) |
| RenewalDate | C | 8 | Home owner insurance policy |
| | | | expiration date (CCYYMMDD) |
| Name | | | |
| Last | C | 25 | Home owner last name |
| First | C | 20 | Home owner first name |
| Middle | C | 20 | Home owner middle name |
| Address | | | |
| Street | C | 60 | Street address line 1 of property |
| | | | location |
| City | C | 28 | City name of property location |
| State | C | 2 | Standard State Abbreviation of |
| | | | property location |
| Zip | C | 5 | 5-digit Zip Code of property |
| | | | location (NO DASHES) |
| Zip4 | C | 4 | +4 portion of Zip Code of property |
| | | | location (NO DASHES) |
| Customer Company | C | 9 | Sub Reporting Customer |
| | | | Company ID Number |

Using the required and optional fields disclosed above (of course, any combination of the fields may be used), an example input file in XML format generated by a graphical user interface or by a customer application may appear as follows:

```
<FireSafeRequest Customer ReportingAccount DataType>
  <Config PolygonDistance Product >
  <Policies>
    <Policy Number Agency QuoteBack RenewalDate SubAccount>...
      <Name First Middle Last/>
      <Address Street City State Zip Zip4/>
    </Policy>
  </Policies>
</FireSafeRequest>
```

A location unit receives, by way of an input file such as has been described above, the address from the customer interface. The location unit will reform the address to a standard format usable by the rest of the system. The location unit geocodes the address. This geocoding represents a hierarchy of location accuracy levels. The location unit is able to determine a latitude and a longitude for the address and for the street segment of the address. The location unit also is able to determine whether a ZIP+4 code, a ZIP+2 code or Zip Code Only corresponding to the address, if an exact address is not known.

If multiple possible locations are found corresponding to an address, the customer interface can send a message to the customer requesting they choose one of the multiple addresses returned. When the customer specifies which of the multiple addresses is the desired address, the system will continue assessing fire risk with respect to that address.

Although the location unit will prefer the exact latitude and longitude of the address, this may not be possible, due to housing developments or other changes in street addressing. If an exact location is not determinable, the location unit will assume that the center of the area corresponding to the most accurate ZIP code is the location of the address, and will assign a latitude and a longitude corresponding to that location. For example, the location unit will prefer the center of the ZIP+4 area, if known, rather than the ZIP+2 area.

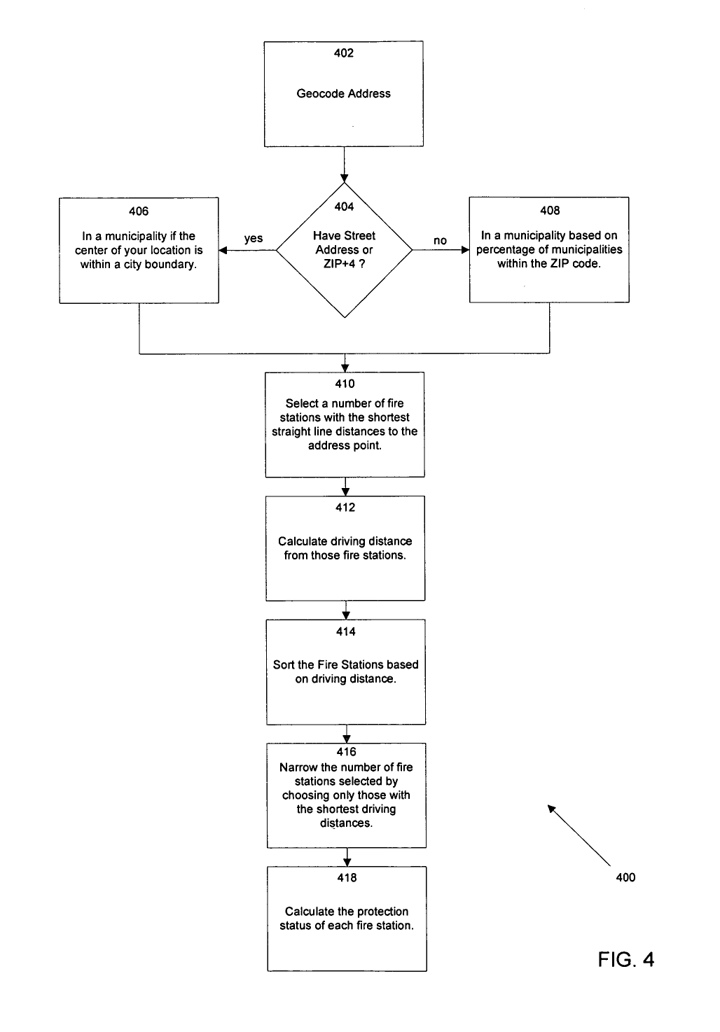

The location unit determines whether the address is within a municipality. If a location is within a municipality or within a customer-defined distance from a municipality, it is assumed by the system that water will be available to combat any area fires. Data such as TIGR municipality data are used to determine if the latitude and longitude are within a municipality. If the exact location of the address is determined, this operation involves determining whether that point is within a municipality boundary. If a ZIP area estimation was used to locate the address, the location unit will determine the percentage of the ZIP code area that is populated with municipalities, for example, as illustrated and described in connection with FIG. 4. If this is above a certain customer-preset percentage of the area, the location unit will assume that the address is within a municipality.

The location unit accesses a database containing locations of many fire stations. Fire station information is drawn from this database, which contains a list of many fire stations and, for each station, the fire station name, address, phone number and type. The name field provides the general identifier for the fire station. The fire station address is used to determine straight line, Manhattan, and driving distances from the station to the customer-entered address. The type field provides information about the station, for example, whether the station is a full time or a volunteer fire station.

The location unit computes straight-line and Manhattan (right angle) distances, and selects a certain number of stations with the shortest straight-line distance. The location unit then computes driving distances for these stations, and selects the shortest distances from among them, including the station assigned to respond to a given address if this can be determined.

A specific example of this fire station selection operation is as follows: An address is entered. Straight line distances from all fire stations in the database are computed, and 8 fire stations are selected because they have the shortest straight-line distance to the address. Driving distances from these 8 fire stations are computed, and the 3 shortest driving distances are selected.

In an example embodiment, driving distances are calculated by a mapping module within the location unit, which may be third party software, such as that provided by MapInfo®. In a possible embodiment of the present disclosure, software packages such as SpatialWare® and Envinsa from MapInfo® can be used.

A protection status unit accepts as input the municipality and drive distance information from the location unit. The protection status unit provides a yes/no classification to two questions: First, is the address within a municipality or within a customer-defined number of miles away? Second, is the fire station within a customer-defined number of miles away? Based on the yes/no classifications to these questions, a fire protection status is assigned to the address.

In a possible embodiment of the present disclosure, one of three fire protection status levels is assignable to a given address: protected, partially protected, and unprotected. Of course, other statuses could be used. Table 3 shows how this determination is made:

TABLE 3

| | Within X miles | Outside of X miles |
|---|---|---|
| | driving distance | driving distance from |
| | of the fire station | the fire station |
| Inside Municipality | Protected | Unprotected |
| Outside of Municipality | Partially Protected | Unprotected |

In Table 3, the X miles driving distance is a customer-preconfigured variable.

The customer interface unit returns the location, distance, fire station, and protection status information to the customer. The customer interface may also display a map showing the address and the closest fire stations determined by the location unit.

In a possible embodiment of the present disclosure, a customer interface contains a range of XML variables it outputs to either a customer application or to an optional web application. An example set of output variables may be as described in Table 4:

TABLE 4

| Field Name | Type | Length | Description |
|---|---|---|---|
| FireSafeResult | | | |
| Customer | N | 9 | Customer Account Number |
| ReportingAccount | N | 9 | Customer Account Number |
| DataType | C | 1 | Represents type of data that is sent. P = Production, T = Test |
| Config | | | |
| PolygonDistance | N | 2.2 | Future use but present |
| Product | | | Future use but present |
| Policy | | | |
| Number | C | 32 | Insurance Policy Identifier (Returned in output without |
| | | | modification) |
| Agency | C | 32 | Insurance Agency Identifier (Returned in output without |
| | | | modification) |
| QuoteBack | C | 60 | For customer use only (Returned in output without |
| | | | modification) |
| RenewalDate | C | 8 | Home owner insurance policy expiration date |
| | | | (CCYYMMDD) |
| ExploreRequestID | N | 9 | From our processing, used for support purposes |
| SubAccount | C | 9 | Sub Reporting Customer Company ID Number |
| Name | | | |
| Last | C | 25 | Home owner last name |
| First | C | 20 | Home owner first name |
| Middle | C | 20 | Home owner middle name |
| Address | | | |
| Street | C | 60 | Street address line 1 of property location |
| City | C | 28 | City name of property location |
| State | C | 2 | Standard State Abbreviation of property location |
| Zip | C | 5 | 5-digit Zip Code of property location (NO DASHES) |
| Zip4 | C | 4 | +4 portion of Zip Code of property location (NO |
| | | | DASHES) |
| Standardized Address | | | |
| Street | C | 60 | Street address line 1 of property location |
| City | C | 28 | City name of property location |
| State | C | 2 | Standard State Abbreviation of property location |
| Zip | C | 5 | 5-digit Zip Code of property location (NO DASHES) |
| Zip4 | C | 4 | +4 portion of Zip Code of property location (NO |
| | | | DASHES) |
| Geocoding | | | |
| Longitude | N | 12 | Longitude of the residence in millionths of a degree |
| | | | (carried to 6 dec) |
| Latitude | N | 12 | Latitude of the residence in millionths of a degree (carried |
| | | | to 6 dec) |
| MatchCode | C | 1 | Values 0-7 |
| MatchAccuracy | C | 8 | Data the system was able to match |
| Match | C | 9 | Alpha-numeric code that encapsulates information about |
| | | | the address standardization process |
| Location | C | 5 | Alpha-numeric code that encapsulates information about |
| | | | the address geocoding process. |
| Error | | | |
| Code | C | 5 | Type of error incurred during processing of the Address |
| | | | Record |
| Message | C | 80 | Description of Error Code |
| Fire Station 1 through 3 | | | |
| ID | C | 6 | Unique Explore Fire Station ID |
| Type | C | 10 | Service Type Indicator for Fire Station (FT = Full Time, |
| | | | PT = Part Time, VOL = Volunteer, FT/VOL = Full Time and |
| | | | Volunteer, MLT = Military, COMM = Commercial, |
| | | | ARPT = Airport) |
| Name | C | 60 | Name of the fire station |
| Phone | C | 13 | Phone number of fire station |
| Address | | | |
| Street | C | 60 | Address of the fire station |
| City | C | 28 | City of the fire station |
| State | C | 2 | State of the fire station (abbr.) |
| County | C | 15 | County of the fire station |
| Zip | C | 10 | Zip code of the fire stationA |
| Zip4 | C | 10 | 4 digit extension of the zip code of the fire station |
| Distance | | | |
| Straight | N | 16 | Straight-line distance between geocoded point and located |
| | | | point (miles) (Quick Batch only) |
| Manhattan | N | 16 | Manhattan distance between geocoded point and located |
| | | | point (miles) |
| Drive | N | 16 | Drive distance between geocoded point and located point |
| | | | (miles) |
| Protection | | | |
| Code | C | 2 | Unique Explore Protection Status ID (1 = Protected, 2 = Partially |
| | | | Protected, 3 = Unprotected) |
| Description | C | 19 | Returns Protected, Partially Protected and Unprotected |
| Responding | C | 1 | Y/N indicator relative to fire station being the first |
| | | | responder |
| CustomerCode | C | 2 | Future Use but present. |

Using the above described variables, an output file sent in XML format from the customer interface to a customer application may appear as follows:

```
<FireSafeResult Customer ReportingAccount DataType >
  <Policies>
    <Policy ExploreRequestID Number Agency QuoteBack
    RenewalDate SubAccount>...
      <Name First Middle Last/>...
      <Address Street City State Zip Zip4 />(original data)
      <StandardizedAddress Street City State Zip Zip4 Longitude
      Latitude MatchCode MatchAccuracy/>...
      <Error Code Message>
      <Firestations>
        <Firestation ID Type Name Phone>...
          <Address ID City County State Zip/>
          <Distance Straight Manhattan Drive/>
          <Protection Code Description CustomerCode Responding/>
        </Firestation>
      </Firestations>
    </Policy>
  </Policies>
```

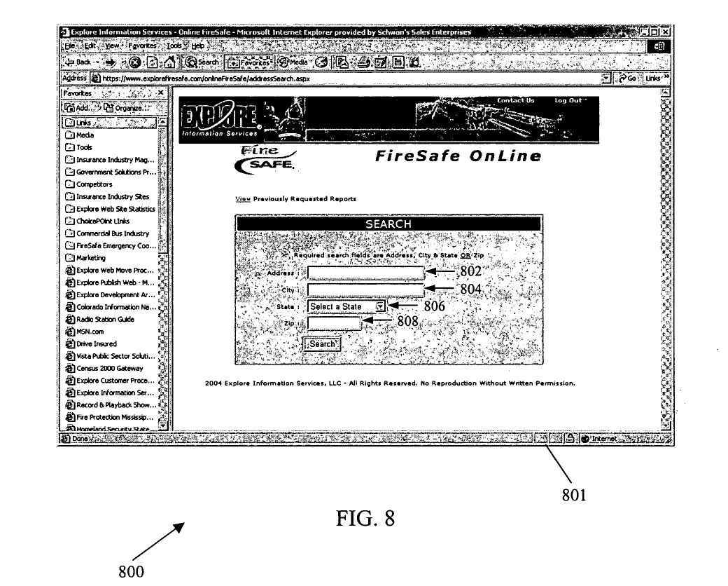

In an embodiment of the present disclosure involving a web application, this XML report is routed within the customer interface to a web application. An example of such a web application is displayed and discussed in connection with FIGS. 8-11. These reports may then be viewed using a web browser or printed from a format conducive to printing.

Referring now to the drawings, aspects of the present disclosure and an exemplary operating environment will be described. First a structure will be described, followed by operational interrelations of the structure to accomplish the fire risk assessment explained above.

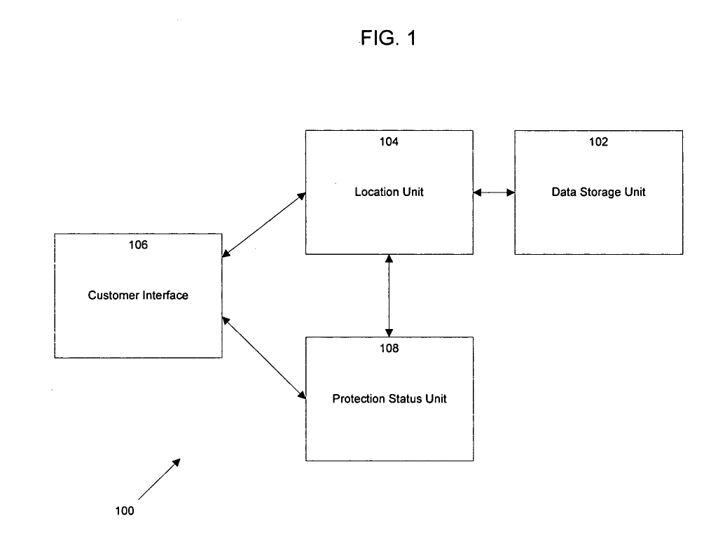

Referring to FIG. 1, a schematic representation of a fire risk assessment system 100 is illustrated. A data storage unit 102 contains geographical location information pertaining to a large number of fire stations. A location unit 104 is operatively connected to the data storage unit 102. The location unit 104 is configured to accept a customer-entered address. The location unit 104 geocodes the customer-entered address. The location unit 104 calculates a driving distance from one or more of the nearest fire stations to the customer-entered address. The location unit 104 assigns a municipality status determined by whether the property at that address resides within a municipality.

A customer interface 106 is associated with the location unit 104. The customer interface 106 is capable of accepting the customer-entered address. The customer interface 106 is also capable of outputting distance and protection status data.

A protection status unit 108 is operatively connected to the location unit 104 and customer interface 106. The protection status unit 108 is capable of calculating a fire protection status that corresponds to the customer-entered address.

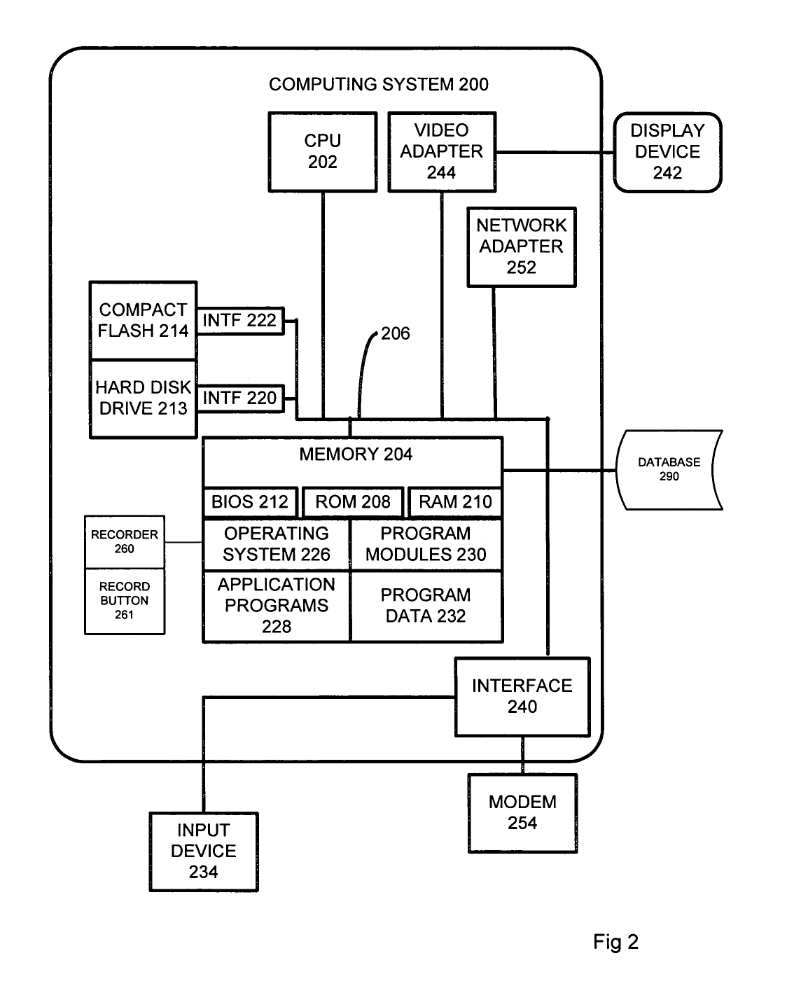

Referring now to FIG. 2, an exemplary environment for implementing embodiments of the present disclosure includes a general purpose-computing device in the form of a computing system 200, including at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start-up, is typically stored in the ROM 208.

Preferably, the computing system 200 further includes a secondary storage device 213, such as a hard disk drive, for reading from and writing to a hard disk (not shown), and a compact flash card 214.

The hard disk drive 213 and compact flash card 214 are connected to the system bus 206 by a hard disk drive interface 220 and a compact flash card interface 222, respectively. The drives and cards and their associated computer-readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user may enter commands and information into the computing system 200 through an input device 234. Examples of input devices might include a keyboard, mouse, microphone, joystick, game pad, satellite dish, scanner, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254 or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

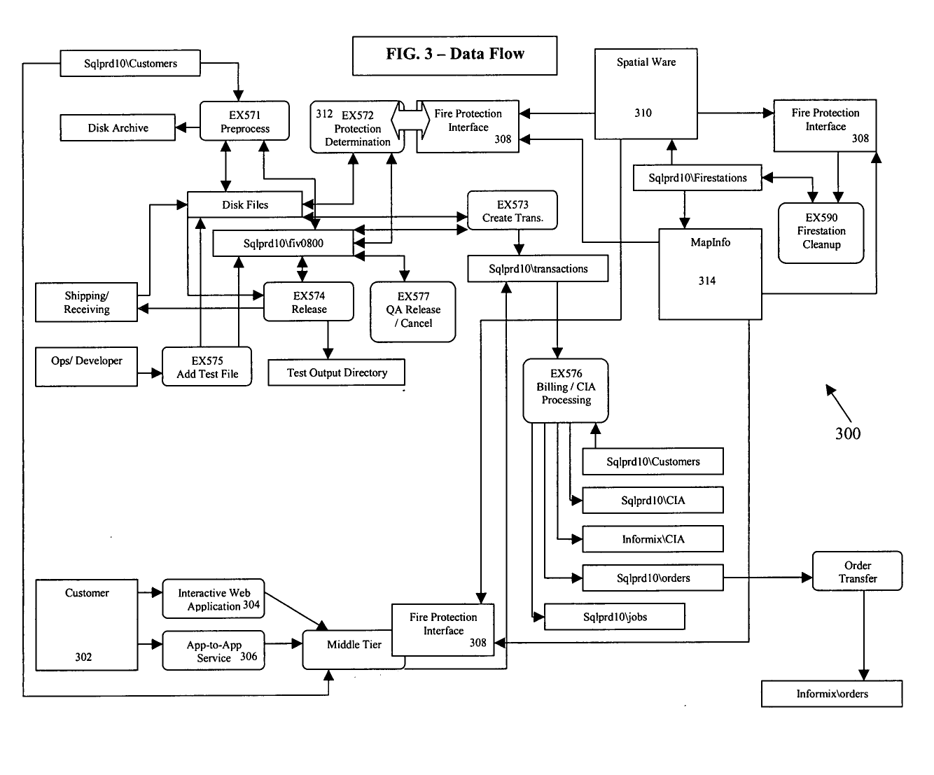

Referring to FIG. 3, a block diagram of the dataflow in a fire risk assessment system 300 is shown according to one possible embodiment of the present invention. A customer 302 utilizes the risk assessment system through an interactive web application 304 or an application to application service 306 to enter an address. The address is passed to a fire protection interface 308. The fire protection interface drives an algorithm such as the one shown in FIG. 4. A locator application 310 is used to determine the location of the address and nearby fire stations. A protection determination module 312 assigns a protection status. A mapping application 314 places the fire stations and the address on a map for display back to the customer 302 through the fire protection interface 308. As illustrated, other operations or modules can also be utilized.

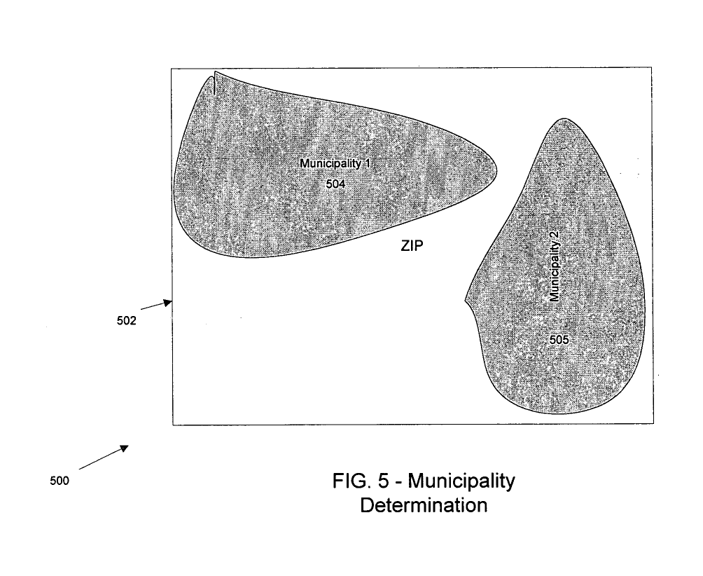

Referring to FIG. 4, a flowchart of a risk assessment system is shown. A geocode address module 402 accepts an address and determines a longitude and a latitude corresponding to that location. A determination operation 404 considers the accuracy of the location provided. If a street level address was found or a ZIP+4 area is located, then the location was found with reasonable confidence. In this case, a point comparison module 406 determines if the latitude and longitude is within a municipality. If only a ZIP or a ZIP+2 area is located, then there is lower confidence in the accuracy of the location provided. In this case, a percentage module 408 determines whether the address is within a municipality as described in FIG. 5.

A straight line fire selector module 410 selects a number of fire stations with the shortest straight-line distances to the address entered. A driving distance module 412 determines the driving distance from these fire stations to the address. A sort module 414 reorders the fire stations based on the shortest driving distances. A selection module 416 chooses one or more of the fire stations with the shortest driving distances. A protection status module 418 assigns a fire protection status to each fire station based on the municipality and distance determinations.

Referring to FIG. 5, a diagram illustrating a municipality status determination of a vague address according to one possible embodiment of the present invention is shown. This determination is made only when an exact location of an address is not possible, and only a ZIP code or a ZIP+2 code is available. A ZIP code area 502 contains one or more municipalities 504, 505. The municipalities 504, 505 occupy a certain percentage of the area occupied by the ZIP code 502. A customer provides a certain percentage area of a ZIP code that must be populated with municipalities to assume that the approximated location is within a municipality. If more of the ZIP code is populated with municipalities than the customer entered percentage, it is assumed that the address entered is within a municipality.

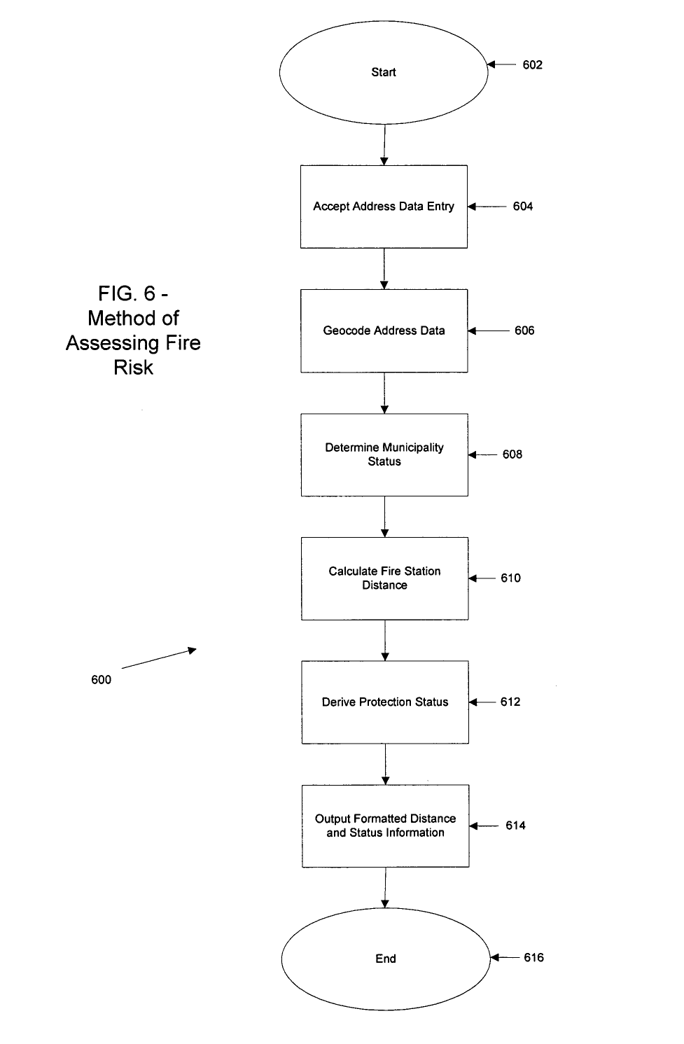

Referring to FIG. 6, a flow diagram of a method of assessing fire risk 600 is shown. A start point 602 initiates the method 600 upon a customer logging in to the system. An address accept module 604 accepts address data from the customer, formats the address, and verifies its accuracy. A geocode address module 606 determines the geographical location corresponding to the address. A determination module 608 assigns a municipality status to the location. A distance calculation module 610 measures the straight-line, Manhattan, and driving distances to fire stations nearest to the address. A protection status module 612 assigns a protection status to the address. An output module 614 returns distance, geocode, and protection status information to the customer. An end point 616 completes the method.

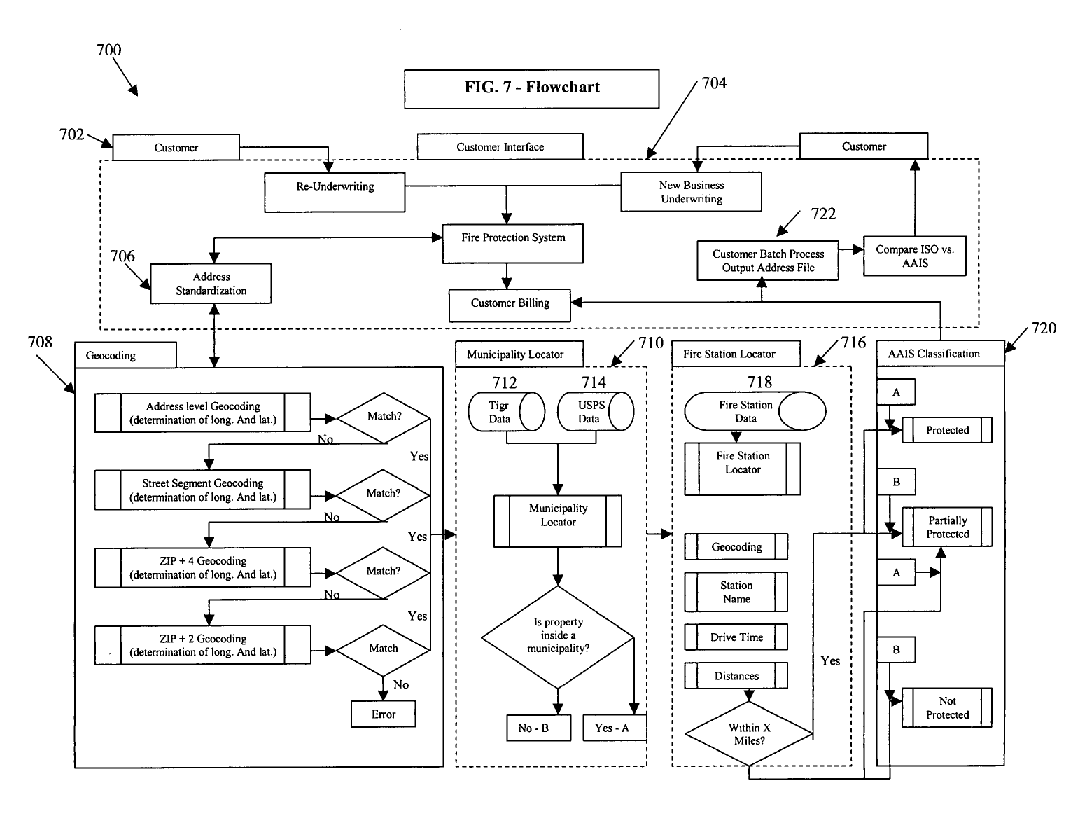

Referring to FIG. 7, a flowchart of a method and system 700 of assessing fire risk according to an example embodiment of the present disclosure is shown. A customer 702 enters address data into a customer interface 704. The address is standardized by an address standardization module 706.

The standardized address is geocoded by a geocoding module 708. The geocoding module iteratively tests address information. The geocoding module 708 prioritizes address accuracy, and performs a series of matching steps to ensure that it has the most accurate matching address, latitude and longitude. For example, an address may not be recognized because it is located within a new housing development. The geocoding module 708 may not be able to locate the street address entered, but may be able to locate a street segment or a ZIP code for the address. The street segment would be the second best option, so, if available, it would be used. Because a ZIP+4 code area is smaller than a ZIP area or a ZIP+2 area, it would be the next preferred location means.

A municipality locator module 710 determines whether the address is located within a municipality. The municipality location module 710 uses TIGR data 712 and USPS data 714 to determine the locations and boundaries of municipalities. The module performs a municipality status determination, such as that described in connection with FIG. 4.

A fire station locator module 716 finds the nearest fire stations and determines driving distances from those stations to the address. The fire station locator module 716 uses fire station data 718 to determine distances to the address, such as that described in connection with FIG. 4.

A protection status module 720 assigns an AAIS classification to the address based on results from the municipality locator module 710 and fire station locator module 716.

Protection status information, driving distances, and address information are returned to the customer 702 through the customer interface 704. The customer interface may generate an output address file 722 containing this information for multiple locations as requested by the customer 702.

Referring to FIGS. 8 through 11, a graphical user interface 800 for a fire risk assessment system is shown according to one possible embodiment of the present invention. This graphical user interface 800 accepts data in the standardized format consistent with the application to application embodiment of the present invention. The graphical user interface 800 is incorporated with the customer interface, and provides the customer data entry and feedback mechanism in absence of a customer-specific application.

Referring to FIG. 8, an address input form 801 in a graphical user interface displayed on a popular Web browser is shown according to an example embodiment. The address input form 801 includes a street address field 802, a city field 804, a state field 806, and a zip code field 808. The address input form 801 provides the web-based structure for a customer to enter an address into the fire risk assessment system.

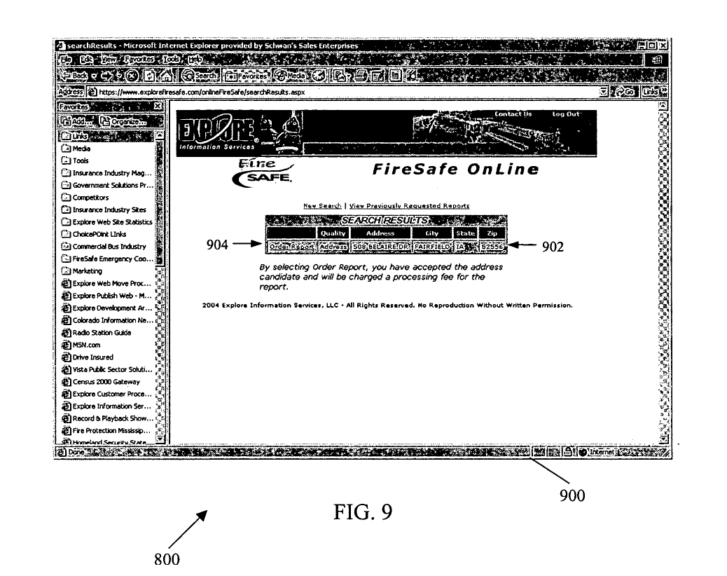

Referring to FIG. 9, a preliminary risk report 900 in a graphical user interface displayed on a popular Web browser is shown according to an example embodiment. The risk report 900 includes an address text display 902 and a report view link 904. The preliminary risk report 900 uses the address text display 902 and report view link 904 to provide a mechanism for a user to verify they are seeking information corresponding to the correct address.

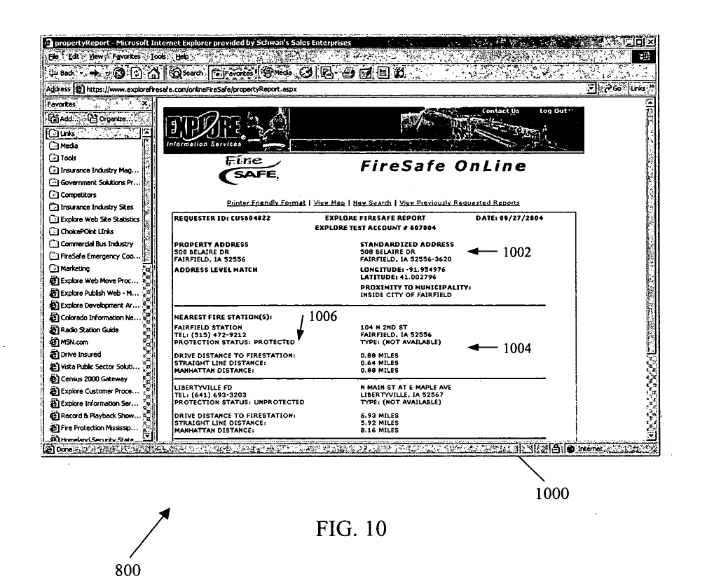

Referring to FIG. 10, a fire risk report 1000 in a graphical user interface displayed on a popular Web browser is shown according to the example embodiment. The fire risk report 1000 includes an address display 1002, fire station information 1004, and fire protection status information 1006. The fire risk report 1000 provides the information sought by the customer related to distance and fire protection status.

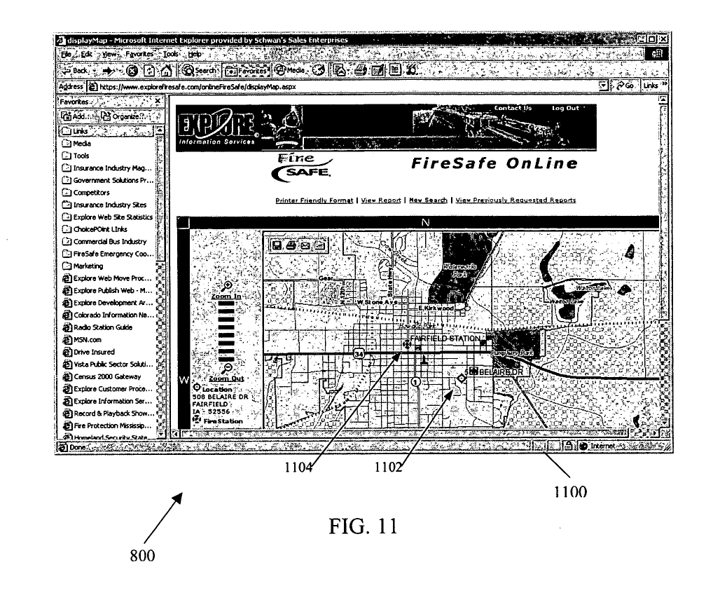

Referring to FIG. 11, a street map 1100 in a graphical user interface displayed on a popular Web browser is shown according to the example embodiment. The street map 1100 includes a customer input address 1102 and locations of one or more nearby fire stations 1104. The street map 1100 graphically displays the location results for the address and fire stations.

The above specification, examples and data provide a complete description of the manufacture and use of the composition of the invention. Since many embodiments of the invention can be made without departing from the spirit and scope of the invention, the invention resides in the claims hereinafter appended.

The claimed invention is:

1. A fire risk assessment system comprising:
a data storage unit containing geographical location information of at least one fire station;
a location unit operatively connected to the data storage unit that accepts an address from the customer interface, geocodes the address, calculates a driving distance from one or more nearest fire stations to the address, and assigns a municipality status determined by whether the property at the address resides within a municipality; and
a protection status unit operatively connected to the location unit and capable of calculating a fire protection status corresponding to the address.

2. The fire risk assessment system according to claim 1 further comprising a mapping unit operatively connected to the location unit, whereby a map of area including the address and one or more nearest fire stations are displayed.

3. The fire risk assessment system according to claim 1 wherein the distance determination unit also computes a straight line and a Manhattan distance from one or more nearest fire stations and the location determined by the address.

4. The fire risk assessment system according to claim 1 wherein the protection status unit calculates the fire protection status based on the municipality status and the distance to the nearest fire station.

5. The fire risk assessment system according to claim 4 wherein a customer is able to configure the protection status unit by assigning a maximum protectable distance from each fire station.

6. The fire risk assessment system according to claim 1 wherein a customer is able to configure the location unit by assigning a minimum percentage of a given zip code to be within any municipality to assume that an incomplete address is within a municipality.

7. The fire risk assessment system according to claim 1, further comprising a customer interface operatively connected to the location unit and capable of accepting the customer-entered address and outputting distance and the fire protection status.

8. The fire risk assessment system according to claim 7 wherein the customer interface requests clarification from a customer if the location unit determines that the customer-entered address is ambiguous.

9. The fire risk assessment system according to claim 7 wherein the customer interface is web-based.

10. The fire risk assessment system according to claim 7 wherein the customer interface is an application-to-application interface.

11. A method of assessing fire risk comprising:
receiving address data;
geocoding the address data;
determining whether the address data corresponds to a location within a municipality;
calculating a driving distance from the address data to at least one nearest fire station;
deriving a protection status corresponding to the address data; and
outputting the driving distance and the protection status.

12. The method according to claim 11 wherein determining includes determining whether the address data corresponds to a location within a municipality based on utilization of intersecting polygons to ascertain whether the address data corresponds to a location within the municipality.

13. The method according to claim 11 wherein determining includes requesting further input if the address data provides an ambiguous location reference.

14. The method according to claim 11 wherein calculating includes calculating a straight line distance.

15. The method according to claim 11 wherein calculating includes calculating a Manhattan distance.

16. The method according to claim 11 wherein deriving includes assigning the protection status based on the determining and calculating operations.

17. The method according to claim 11 wherein outputting includes outputting a map displaying the location and the nearest fire stations.

18. The method according to claim 11 wherein receiving includes receiving address data from a web-based customer interaction.

19. The method according to claim 11 wherein the receiving includes receiving address data from an application to application customer interaction.

20. A graphical user interface connected to a fire risk assessment system comprising:
a first viewing area displaying an address input form, having at least one input field that accepts address data;
a second viewing area displaying a preliminary risk report, containing at least one text field, having address and fire protection status information; and
a third viewing area displaying a fire risk report, that contains at least one text field, having fire protection status information, address information, and distance information.

21. The graphical user interface according to claim 20, further comprising a fourth viewing area displaying a street map, wherein the street map displays a location corresponding to the input address data, at least one nearest fire station, and street information.

22. A computer-readable medium encoding computer-executable instructions for executing on a computer a computer process for assessing fire risk, said computer process comprising:
receiving address data;
geocoding the address data;
determining whether the address data corresponds to a location within a municipality;
calculating a driving distance from the address data to at least one nearest fire station;
deriving a protection status corresponding to the address data; and
outputting the driving distance and the protection status.

23. The computer-readable medium according to claim 22, wherein determining includes determining based on utilization of intersecting polygons to ascertain whether the address data corresponds to a location within the municipality.

24. The computer-readable medium according to claim 22 further comprising requesting further input if the address data provides an ambiguous location reference.

25. The computer-readable medium according to claim 22, wherein receiving includes receiving address data through a web-based customer interaction.

26. The computer-readable medium according to claim 22, wherein receiving includes receiving address data through an application to application customer interaction.

27. A computer-readable medium storing a computer interpretable data structure that identifies one or more fire station locations, the data structure comprising:
a fire station identifier field containing identification data of one or more fire stations;
one or more fire station location fields containing location data corresponding to a physical location of each of the fire stations, the location fields usable to calculate a driving distance to a reference location; and
a type field containing fire station type data corresponding to each fire station.

28. The computer readable medium according to claim 27 further comprising a contact field corresponding to a telephone number for each fire station.

29. The computer readable medium according to claim 27 further comprising a name field corresponding to the name of each fire station.

30. A computer-readable medium storing a computer interpretable data structure that identifies one or more fire station locations, the data structure comprising:
a first data field containing data representing the identity of one or more fire stations;
a second data field derived from the first field by associating fire station location data to a physical location of each of the fire stations, the location data usable to calculate a driving distance to a reference location; and
a third data field derived from the first field by associating fire station type data to each of the fire stations.

31. The computer readable medium according to claim 30, wherein the data structure further comprises a fourth data field representing a telephone number for each fire station.

32. The computer readable medium according to claim 30, wherein the data structure further comprises a fourth data field representing the name of each fire station.
